(19) United States
(12) Patent Application Publication
(10) Pub. No.: US 2002/0163309 A1
(43) Pub. Date: Nov. 7, 2002

(54) Cathode ray tube of the index tube type

(75) Inventors: Marcellinus Petrus Carolus Michael Krijn, Eindhoven (NL); Hendrikus Bernardus Van Den Brink, Eindhoven (NL)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/135,339

(22) Filed: Apr. 30, 2002

(30) Foreign Application Priority Data
May 3, 2001 (EP) 01201607.7

(51) Int. Cl. H01J 29/96

(52) U.S. Cl. 315/3

(57) ABSTRACT

A picture display device comprises a cathode ray tube of the index type for producing at least one electron beam and having a pattern of index elements and parallel phosphor lines. An index signal is produced during operation. In response to the index signal the position of the electron beam is changed by a deflector means. The cathode ray tube comprises an electron gun having a main lens portion and the deflector means comprises at least two electrostatic deflectors (41, 42) positioned in front of the main lens portion (DML), the deflectors having opposite effects.

### DESCRIPTION OF THE PRIOR ART

The invention relates to a picture display device comprising a cathode ray tube having means for generating at least one electron beam, a display screen provided with a phosphor pattern comprising phosphor elements luminescing in different colours and index elements inside an evacuated envelope, and means for deflecting the electron beam across the display screen over the phosphor elements and over the index elements, scanning the electron beam in a direction parallel to the phosphor elements and having means for moving the electron beam in a direction perpendicular to the phosphor elements and imparting video information to the means for generating the electron beam, the picture display device comprising receiving means for receiving data emanating from the index elements, and a deflector means for controlling the deflection of the electron beam(s) in response to said data in a direction transverse to the phosphor elements.

Picture display devices of the index type are known and are usually referred to as ‘index’ display devices. As compared with the conventional picture display device, in which the cathode ray tube is provided with a colour selection electrode (also referred to as shadow mask), such index display devices have the advantage that, due to the absence of the shadow mask, they have a smaller weight. They require less energy and the sensitivity to vibrations and temperature differences and variations is reduced. This is offset by the fact that, due to the absence of the shadow mask, the sensitivity to disturbing effects of parasitic (electro)-magnetic fields, including the earth's magnetic field, is much greater and much more stringent requirements are imposed on the accuracy with which the beams are generated and deflected.

To obviate and/or reduce the above-mentioned drawbacks, the display screen of an index display device is provided with index elements with which the position and/or the shape of the electron beam(s) can be controlled while they are being deflected across the display screen and over the index elements, which control data are used to correct the deflection and/or shape of the electron beam(s).

A picture display device of the type described in the opening paragraph is known from U.S. Pat. No. 3,147,340. In this patent, a cathode ray tube display device is described in which the electron beam is scanned over the phosphor lines and is deflected, during a scan, in a direction perpendicular to the direction of scan, in this prior art alternately impinging upon a green, red and blue phosphor line, while the electron beam performs a sinusoidal movement in said direction and the video information for each colour is imparted to the cathode when the electron beam hits a corresponding phosphor line. The intensity of the electron beam corresponds to the amount and intensity of the relevant colour at the relevant spot.

Prior art cathode ray tube device of the index tube type are also known in which the electron beam scans the phosphor lines one by one, or in which three electron beams scan the phosphor lines.

Although the known devices have a number of advantages, it is difficult to obtain a high intensity, high colour fidelity image.

The bandwidth of operation of the deflector means has to be at a very high frequency comparable to the video frequency and the deflector means should only influence the deflection, i.e. the position of the beam(s) on the screen, not the shape of the electron beam.

This is very difficult to achieve. This is especially of importance in index tubes, because any change of shape will often lead to a comparable change of position.

### SUMMARY OF THE INVENTION

It is an object of the invention to provide a cathode ray display device which has an improved performance and in which one or more of the above problems are reduced.

To this end, the display device in accordance with the invention is characterized in that the display device comprises an electron gun having a main lens portion, and the deflector means comprises at least two electrostatic deflectors positioned in front of the main lens portion, said electrostatic deflectors having opposite effects.

If, as in many known systems, the deflector means are integrated in the deflection unit or form a separate coil system, the bandwith is less suitable for a high frequency.

Using electrostatic deflectors (basically pairs of electrodes between which a voltage difference is applied) is better suited for the high frequencies involved.

Positioning the deflectors in front of the main lens portion is more advantageous than positioning them behind the main lens portion because the changing deflection current can then be superpositioned on a relatively low voltage instead of being superpositioned on the high anode voltage.

Using only one pair of electrodes would mean that a change of position of the electron beam on the screen would also involve a change of position of the electron beam in the main lens portion. Using two pairs of electrodes (or more) enables the position of the electron beam on the screen to be varied while yet substantially keeping the position of the electron beam in the main lens (and thereby many of the characteristics of the electron beam as apparent on the screen) constant.

Combination of these characteristics provides a deflector means comprising a series of at least two pairs of electrodes in front of the main lens portion of the electron.

It is to be noted that the index signal given by the index elements is dependent on the position of the electron beams vis-à-vis the index element, as well as on the shape of the electron beam, including the focus and imaging errors. Therefore, if a change of position is accompanied by a change of shape, a proper indexing action becomes difficult. The device in accordance with the invention removes or at least substantially reduces these problems.

These and other aspects of the invention are apparent from and will be elucidated with reference to the embodiments described hereinafter.

### BRIEF DESCRIPTION OF THE DRAWINGS

In the drawings:

FIG. 1 shows schematically a cathode ray tube,

FIG. 2 shows an electron gun for use in a device according to the invention in which two pairs of electrodes for electrostatically deflecting the electron beam are integrated in the electron gun in front of the main lens portion.

FIGS. 3 and 4 show schematically possible deflection schemes for a picture display device according to the invention.

FIG. 5 illustrates schematically a driving scheme.

The Figures are not drawn to scale. Generally, identical components are denoted by the same reference numerals in the Figures.

### DESCRIPTION OF PREFERRED EMBODIMENTS

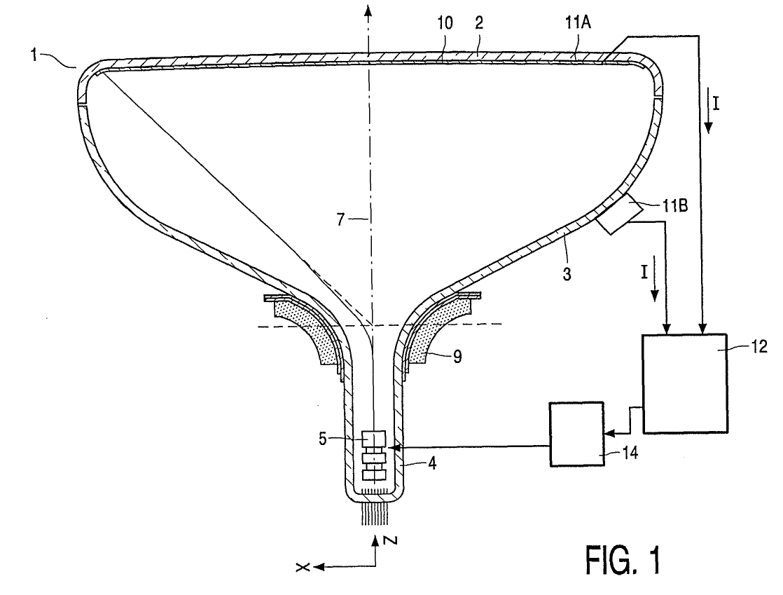

The cathode ray tube shown in FIG. 1 is a colour cathode ray tube 1 having an evacuated envelope comprising a display window 2, a cone 3 and a neck 4. The neck 4 accommodates an electron gun 5 for generating one electron beam 7, in this embodiment, in one plane, the in-line plane. A display screen 10 is situated on the inner side of the display window 3. The display screen 10 comprises a plurality of red, green and blue-luminescing phosphor elements. Each group of (red, green or blue) phosphor elements forms a pattern. The display screen may also comprise other patterns such as a black matrix (a black pattern) or color filter patterns. The electron beam is scanned across the display screen by means of, in this example, an electromagnetic deflection unit 9. The display screen patterns are provided with index elements in cathode ray tubes of the index type. The signals emanating from said index elements are detected by detection means, for instance a pattern of (UV) light emitting index element 11A on the screen in conjunction with a light detector 11B, or a pattern 11A of electrically conducting index elements. As the electron beam(s) pass over them, these index signals are indicative of the position and/or shape of the electron beam(s). These index signals are sent to a means 12 for analysis. Usually, said means comprises means for deriving control signals for controlling the deflection and/or shape of the electron beams which are sent to electrostatic deflectors in the electron gun 5 via means 14.

Deflector means could be integrated in the deflection unit or by a separate coil system in the deflection unit. However, the inventors have realised that the bandwidth of operation of the main deflection unit is less suitable for the high frequency at which the deflector acting on the index signals has to operate. Special coil systems, which are usually smaller are better suited, but still leave room for improvement.

Using electrostatic deflectors (basically pairs of electrodes between which a voltage difference is applied) is better suited for the high frequencies involved. These electrostatic deflectors could be positioned in front of and behind the main lens portion of the electron gun.

Positioning the deflectors in front of the main lens portion is more advantageous than positioning them behind the main lens portion because the changing deflection current can then be superpositioned on a relatively low voltage instead of being superpositioned on the high anode voltage.

Using only a single electrostatic deflector, e.g. a single pair of electrodes would mean that a change of position of the electron beam on the screen is accompanied by a change of position of the electron beam in the main lens portion. Using two electrostatic deflectors with opposite action, e.g two pairs of electrodes (or more) enables the position of the electron beam on the screen to be varied while yet substantially keeping the position of the electron beam in the main lens (and thereby many of the characteristics of the electron beam as apparent on the screen) constant.

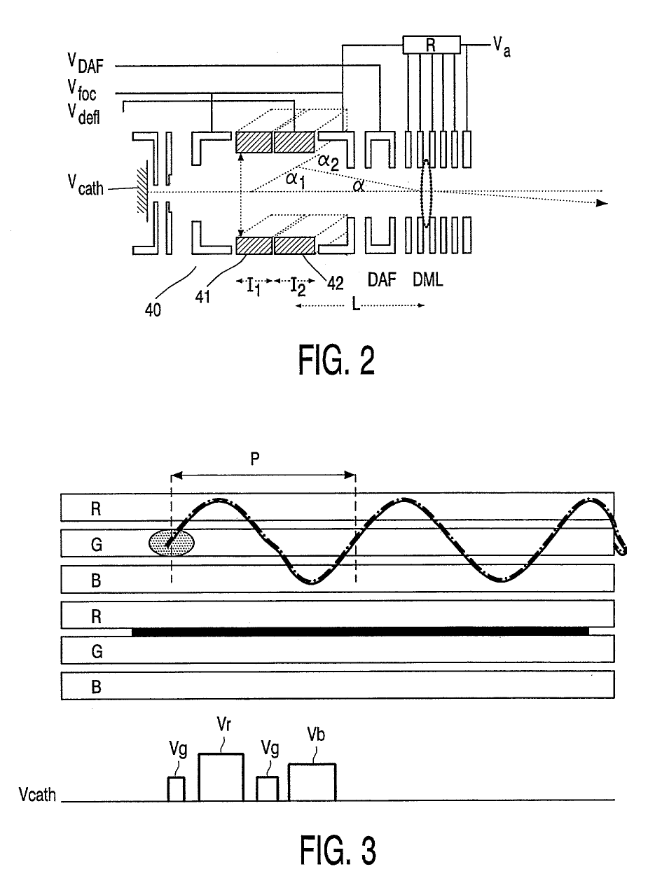

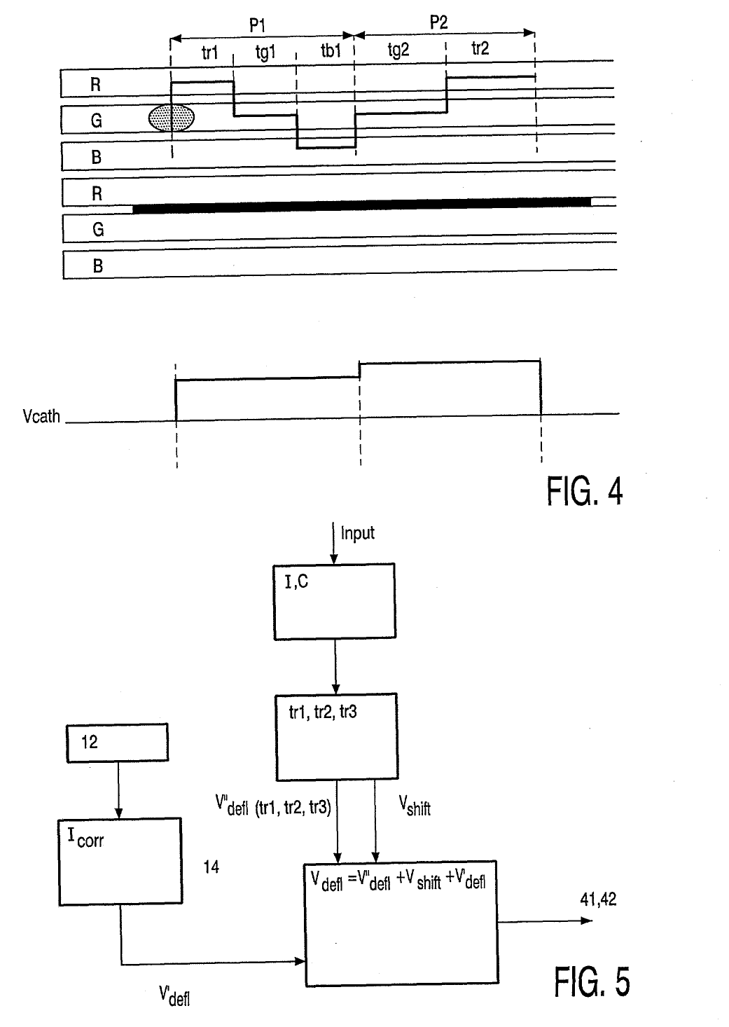

The deflector is integrated (see FIG. 2) in the electron gun and, in this example, positioned inside the focus bus 40 of the gun and comprises two pairs of electrodes 41 and 42 for generating, in this example, two consecutive deflection dipoles generating vertical deflection fields with opposite signs. Indicated in the Figure are the main lens part, which in this example is a distributed main lens (DML), the first electrode of which is fed in operation with the anode voltage (Vₐ) and distributed across the different electrodes of the distributed main lens part. Viewed from the cathode to which the cathode voltage V_{cath} is supplied in operation is a Dynamic Astigmatism and Focusing electrode DAF which is preceded by the focus bus 40. The focus bus voltage V_{foc} is supplied to the focus bus. Two electro-static deflectors in the form of the two pairs of electrodes 41 and 42 are provided inside the focus bus. The electrodes are through-connected, as is schematically indicated in FIG. 2. The first of the electrostatic deflectors deflects the electron beam through an angle alphal, the second redeflects the electron beam back to the central line. A difference between the deflection voltage V_{defl} and the focus voltage V_{foc} brings about a deflection of the electron beam in the vertical direction. Preferably, the excitation of the two pairs of electrodes is chosen to be such that, in a first order approximation, the position of the beam in the main lens is independent of the excitation of the electrodes in order not to change the spot performance, but only the position of the spot on the screen. Preferably, the lengths of the electrodes are chosen to be such that the electrodes of both pairs can be through-connected (as schematically indicated in FIG. 2) which obviates the need for two separate deflection voltages. The deflection voltage for obtaining a shift of 100 μm is typically in the range of several tens of volts, which can easily be superposed on the focus voltage with the required frequency bandwith. It is to be noted that, in preferred embodiments, the deflector is used simultaneously for indexing purposes but preferentially also for shifting the vertical position of the electron beam(s) as schematically indicated in FIGS. 3 and 4. In this manner, the deflector means serves two purposes, namely performing index corrections and shifts for color rendition without this having any influence on the spot performance.

FIG. 2 shows schematically a detail of a picture display device as known from U.S. Pat. No. 3,147,340. The display screen 10 comprises phosphor lines R, G, B spaced apart from each other. The electron beam performs a sinusoidal movement (indicated by the drawn sinusoidal line with a period P, corresponding to an image pixel). The black line represents an index element. The cathode voltage (and therewith a measure for the beam intensity) is indicated below the schematic representation of the phosphor screen and the movement of the electron beam across the phosphor screen. This sinusoidal movement can be effected by the gun as schematically shown in FIG. 2.

As the beam scans the phosphor lines, the intensity is varied as indicated. Although the device in accordance with the invention is suited for such an embodiment, the inventors have realised that two problems arise. The frequency of change in the cathode voltage is very high (three times the video frequency) and even a slight offset in a direction transverse to the phosphor lines greatly influences the color rendition, since it changes the times during which the electron beam impinges on the different lines. If the electron beam is scanned slightly too high, as indicated by the dotted-striped line in FIG. 3, the electron beam impinges on the red phosphor line for a longer time and on the blue phosphor lines for a shorter time. These two negative effects reinforce each other.

A preferred deflection scheme for color rendition is schematically shown in FIG. 4. The position of the electron beam is altered in each pixel between the red, green and blue phosphor lines but the cathode voltage remains the same, i.e. is substantially held constant. During the first pixel P1, the electron beam impinges on the red phosphor line during a time period tr1, on the green phosphor line during time period tg1 and on the blue phosphor line during a time period tb1 in this example. During pixel P2, the electron beam impinges on the green phosphor line during tg2 and on the red phosphor line during tr2.

An upward or downward shift of the phosphor line does not (in first order approximation) have an effect on the color rendition. Secondly the cathode voltage is changed much less in frequency (at the video frequency instead of at three times the video frequency) and generally also less in amplitude changing with the overall intensity rather than with the intensity for each color. Furthermore, on average, the efficiency is increased.

It is to be noted that the cathode voltage is held substantially constant. Inevitably there are some transitional effects when the cathode voltage is changed from one level to another level, i.e. a rising and/or a sloping flank. It is important that one and only one step is made per pixel so that the cathode voltage is changed much less in frequency than in the situation shown in FIG. 3. It is noted that these flanks themselves change the color rendition to some extent. The effect of a large step on the color rendition is greater than the effect of a small step. Also in this respect, the invention as schematically shown in FIG. 4 is advantageous as compared with the situation shown in FIG. 3, because fewer in cathode voltage steps are needed and, on average, the cathode voltage steps are smaller.

Preferably, the pixels are written in the sequence RGB, BGR, RGB, BGR, i.e. the sequence of writing the red and blue phosphor is altered between adjacent pixels. This reduces the number of movements perpendicular to the phosphor stripes the electron beam has to make by one-third. Preferably, if the color is such that tg1 is very small as compared to both tr1 and tb1, the centre line of the movement of the electron beam is shifted from green to red (or blue), i.e by one phosphor line. In the scheme as schematically shown in FIG. 4, a color with much red and blue, but very little green is difficult to produce, since the electron beam always has to crosover from the red phosphor line to the green phosphor line. This will take a finite time, thus tg1 will be larger than said finite time, so the color will always comprise a green component. By shifting the centre line one third of a triplet i.e. one phosphor line, the green phosphor line need not be crossed and colors with no or only a very small green component can be obtained.

FIG. 5 illustrates schematically a scheme for driving a deflector means. The intended intensity I and the colour C of the pixel can be calculated from the input data. The dwell times tr1, tr2, tr3 are calculated from this data, which can be understood to form the color and intensity signals. The deflection voltage V″_{defl} is calculated from these color signals and possibly also a shift voltage V_{shift} to shift the pixel by a phosphor line in accordance with a preferred embodiment. Furthermore, means 12 supplies correction data I_{corr} (which can be understood to form index signals) to means 14, from which correction data a deflection voltage V′_{defl} can be calculated. The sum of all these voltages is calculated and applied to electrodes 41, 42 so that the deflector means simultaneously performs position corrections (in response to the index signals) and color selection (in response to color signals).

In summary, the invention may be described as follows.

A picture display device comprises a cathode ray tube of the index type for producing at least one electron beam and having a pattern of index elements and parallel phosphor lines. An index signal is produced during operation. In response to the index signal, the position of the electron beam is changed by a deflector means. The cathode ray tube comprises an electron gun having a main lens portion and the deflector means comprises at least two electrostatic deflectors positioned in front of the main lens portion, the deflectors having opposite effects.

It will be evident that many variations are possible within the scope of the invention.

1. A picture display device comprising a cathode ray tube (1) having means (5) for generating at least one electron beam, a display screen (10) provided with a phosphor pattern comprising phosphor elements luminescing in different colours and index elements inside an evacuated envelope, and means (9) for deflecting the electron beams across the display screen over the phosphor elements and over the index elements, scanning the electron beam in a direction parallel to the phosphor elements and having means for moving the electron beam in a direction perpendicular to the phosphor elements and imparting video information to the means for generating the electron beam, the picture display device comprising receiving means (12) for receiving data emanating from the index elements, and a deflector means for controlling the deflection of the electron beam(s) in response to said data in a direction transverse to the phosphor elements, characterized in that the display device comprises an electron gun having a main lens portion, and the deflector means comprises at least two electrostatic deflectors (41, 42) positioned in front of the main lens portion (DML), said electrostatic deflectors having opposite effects.

2. A display device as claimed in claim 1, characterized in that the electrostatic deflectors comprise two pairs of electrodes which are through-connected.

3. A display device as claimed in claim 1, characterized in that, in operation, the deflector means is responsive to index signals as well as to color selection signals.
